(19) United States
(12) Patent Application Publication
(10) Pub. No.: US 2014/0028509 A1
(43) Pub. Date: Jan. 30, 2014

(54) TERMINAL AND METHOD FOR USING A PIEZOELECTRIC MODULE AS AN ANTENNA

(71) Applicant: PANTECH CO., LTD., Seoul (KR)

(72) Inventors: Myeong Je Kim, Seoul (KR); Jong Hoon Oh, Seoul (KR)

(21) Appl. No.: 13/946,695

(22) Filed: Jul. 19, 2013

(30) Foreign Application Priority Data
Jul. 24, 2012 (KR) 10-2012-0080538

(51) Int. Cl. H01Q 1/44

(52) U.S. Cl. CPC H01Q 1/44
USPC 343/720

(57) ABSTRACT

Terminals, apparatuses and methods for operating a piezoelectric module included in a terminal in one or more operation modes, including: a control unit which determines an operation mode of a piezoelectric module that includes a piezoelectric element, the piezoelectric module operating according to the operation mode determined by the control unit; and a voltage control unit which applies an operation voltage for generating an operation frequency according to the operation mode determined by the control unit to the piezoelectric module. The one or more operation modes includes an antenna mode in which the piezoelectric module operates as an antenna in the terminal. Accordingly, the antenna is implemented using the piezoelectric module in the terminal, thereby promoting and enhancing mounting characteristics and durability of the terminal.

### CROSS-REFERENCE TO RELATED APPLICATION

This application claims priority to and the benefits under 35 U.S.C. §119 of Korean Patent Application No. 10-2012-0080538, filed on Jul. 24, 2012, the contents of which are herein incorporated in its entirely by reference for all purposes as if fully set forth herein.

### BACKGROUND

1. Field

Exemplary embodiments relate to terminals, apparatuses and methods for using a piezoelectric module as an antenna, and more particularly, to terminals, apparatuses and methods for causing a piezoelectric module to generate an operation frequency so as to be used as an antenna.

2. Discussion of the Background

As various electronic devices have been applied in everyday life, there is a demand for new forms of user interfaces that have reasonably good quality and sensible appeal. An example of devices among such user interfaces are speakers that provides sound. Such speakers typically have had relatively large volumes. However, the speakers have been gradually reduced in size and thickness to meet the demand of users who want smaller and thinner electronic devices.

FIG. 1 illustrates a piezoelectric speaker formed in a terminal according to the related art. As a speaker that overcomes the limitations on the thickness and is applied to portable devices or thin devices, the exemplary piezoelectric speaker of FIG. 1 having a film form can provide a speaker in which various designs are possible (see FIG. 1).

A piezoelectric technique, such as for use in speakers, promotes providing a small, light, and simple structure, high driving force, low power consumption, non-electromagnetic waves, and linear driving without additional devices. And, is thus widely applied to motors, camera actuators, and the like as well as speakers, for example.

FIG. 2 includes images (a), (b) and (c) to illustrate antennas formed in a terminal according to the related art. In a mobile communication terminal, various antennas, as illustrated in FIG. 2 may be used. Images (a), (b), and (c) of FIG. 2 illustrate examples of a near field communication (NFC) antenna in image (a), a main antenna of a terminal in image (b), and Global Positioning System (GPS) and Bluetooth antennas of the terminal in image (c), respectively. In general, an antenna is a structure that can be used for exchanging modulated and demodulated signals and can be used to transmit and receive signals having electric field intensities to enable communication for subscribers in a cell radius to and from a current mobile communication base station. In addition, the antenna can be employed by terminals carried by the subscribers to be used as an air interface unit that transmits and receives transmission and reception signals to and from the base station. In mobile communications, currently, dipole antennas, Yagi antennas, microstrip antennas, and the like are mainly used, for example.

However, the above-described antennas according to the related art can be restricted by structures having conductivity and mechanical limitation factors. In addition, due to an increase in volume caused by structures of various antennas, a current trend toward a reduction in thickness of terminals may not easily be achieved, and there can be considerations of an increase in cost due to configurations. Moreover, a possible problem than can occur is that, after manufacturing antennas, resonant frequencies and bandwidths are able to be controlled typically only when physical deformation is applied.

### SUMMARY

Exemplary embodiments of the present invention provide terminals, apparatuses and methods for using a piezoelectric module as an antenna, thereby enhancing mounting characteristics and durability.

Exemplary embodiments relate to a terminal to operate a piezoelectric module as an antenna, including: a piezoelectric module including a piezoelectric element to operate according to an operation mode of the terminal, the operation mode including an antenna mode to operate the piezoelectric module as an antenna; a control unit to determine the operation mode of the piezoelectric module to operate the piezoelectric module in the determined operation mode; and a voltage control unit to apply an operation voltage to the piezoelectric module to generate an operation frequency according to the operation mode determined by the control unit.

Exemplary embodiments also relate to a terminal to operate a piezoelectric module as an antenna, including: a piezoelectric module including a piezoelectric element to operate according to a plurality of operation modes of the terminal, the operation modes including one or more piezoelectric modes to operate the piezoelectric module as a speaker or a motor and one or more antenna modes to operate the piezoelectric module as an antenna; a control unit to determine the one or more operation modes of the piezoelectric module to alternately operate the piezoelectric module in one or more of the determined operation modes; and a voltage control unit to alternately apply operation voltages to the piezoelectric module to generate corresponding operation frequencies according to the operation modes determined by the control unit.

Exemplary embodiments further relate to a method for operating a piezoelectric module as an antenna in a terminal, including: determining an operation mode of a piezoelectric module to operate the piezoelectric module in the determined operation mode, the operation mode including an antenna mode to operate the piezoelectric module as an antenna; applying an operation voltage to the piezoelectric module; and generating an operation frequency corresponding to the applied operation voltage according to the determined operation mode.

Exemplary embodiments additionally relate to a method for operating a piezoelectric module in a plurality of operation modes, including: determining one or more operation modes of the piezoelectric module to alternately operate the piezoelectric module in a plurality of operation modes, the operation modes including one or more piezoelectric modes to operate the piezoelectric module as a speaker or a motor and one or more antenna modes to operate the piezoelectric module as an antenna; alternately applying operation voltages corresponding to the determined plurality of operation modes to the piezoelectric module; and generating operation frequencies corresponding to the applied operation voltages according to the determined plurality of operation modes.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a piezoelectric speaker formed in a terminal according to the related art.

FIG. 2 including images (a), (b), and (c) illustrates antennas formed in a terminal according to the related art.

FIG. 3 illustrates a block diagram of an antenna system of a terminal according to exemplary embodiments of the present invention.

FIG. 4 is a cross-sectional view of the piezoelectric module of FIG. 3 according to exemplary embodiments of the present invention.

FIG. 5 including images (a) and (b) are conceptual diagrams illustrating a change in state according to a voltage applied to the piezoelectric module of FIG. 4 according to exemplary embodiments of the present invention.

FIG. 6 illustrates an example in which operation voltages are applied to the piezoelectric module of FIG. 3 according to exemplary embodiments of the present invention.

FIG. 7 illustrates a conceptual diagram of a signal selection unit of FIG. 3 according to exemplary embodiments of the present invention.

FIG. 8 illustrates a block diagram of a GPS antenna system of a terminal according to exemplary embodiments of the present invention.

FIG. 9 illustrates a block diagram of a Bluetooth antenna system of a terminal according to exemplary embodiments of the present invention.

FIG. 10 illustrates a block diagram of a wireless fidelity (WiFi) antenna system of a terminal according to exemplary embodiments of the present invention.

FIG. 11 illustrates a block diagram of an NFC antenna system of a terminal according to exemplary embodiments of the present invention.

FIG. 12 illustrates an example of a piezoelectric module mounted in a terminal where the piezoelectric module is also a motor according to exemplary embodiments of the present invention.

FIG. 13 is a flowchart illustrating a method for implementing an antenna using a piezoelectric module in a terminal according to exemplary embodiments of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Hereinafter, exemplary embodiments of terminals, apparatuses and methods for using a piezoelectric module as an antenna will be described in more detail with reference to the drawings.

It will be understood that when an element is referred to as being “connected to” another element, it can be directly connected to the other element, or intervening elements may be present; and, wireless communication may be interpreted as being wirelessly connected, such as a wireless connection between a terminal and a base station or external server, for example.

Hereinafter, a terminal may include, for example, a mobile communication terminal, handheld, portable or tablet computer or communication devices, or other apparatuses, for using a piezoelectric module as an antenna, will be described in more detail with reference to the drawings, and should not be construed in a limiting sense. Also, the terminal, and the units, modules and components of the terminals herein described, include hardware and software, and can also include firmware, to perform various functions of the terminal including those for using a piezoelectric module as an antenna, including those described herein, as may be known to one of skill in the art. As such, terminal as used herein should not be construed in a limiting sense and may include the above and other apparatuses for using a piezoelectric module as an antenna.

Also, a terminal may include, for example, any of various devices or structures used for wireless or wired communication using a piezoelectric module as an antenna and can be wired or wirelessly connected to a base station, server or network, and may include another terminal, and also may include hardware, firmware, or software to perform various functions for using a piezoelectric module as an antenna, including those described herein, as may be known to one of skill in the art.

Hereinafter, a terminal, such as including, for example, a mobile terminal, a mobile communication terminal, handheld, portable or tablet computer or communication devices, or other apparatuses, and methods for using a piezoelectric module as an antenna will be described in more detail with reference to the drawings.

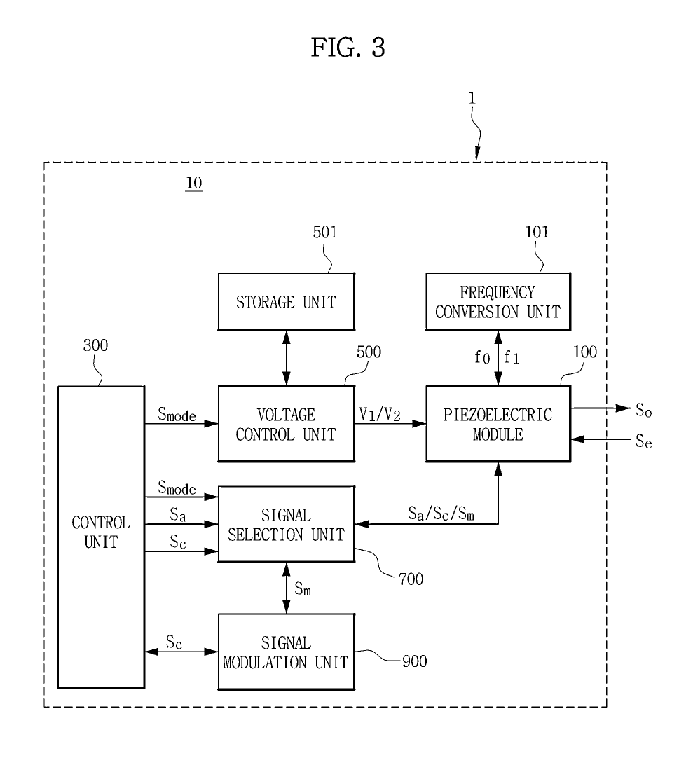

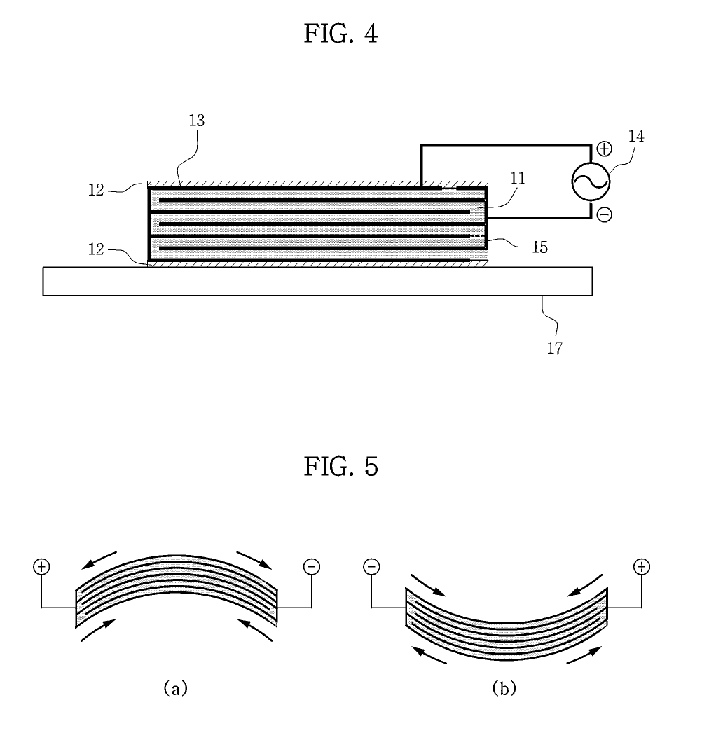

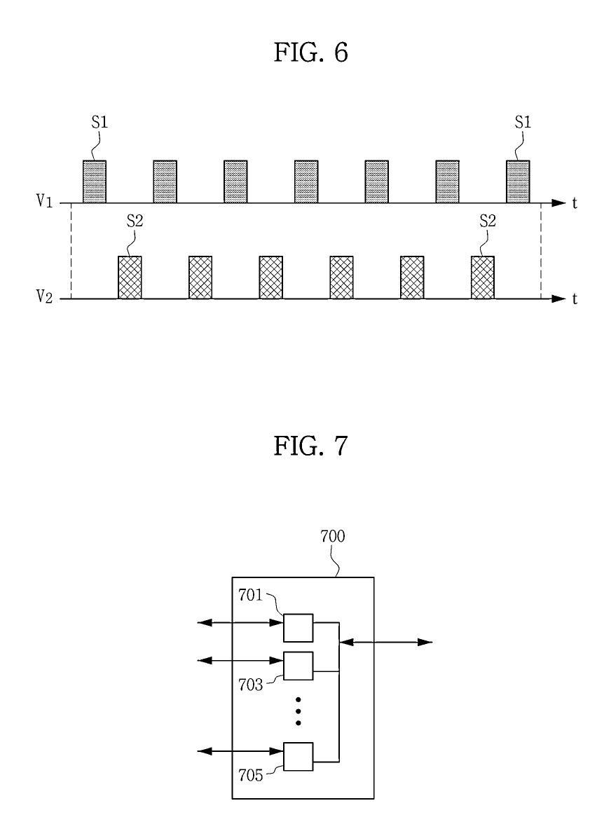

FIG. 3 illustrates a block diagram of an antenna system of a terminal according to exemplary embodiments of the present invention. FIG. 4 is a cross-sectional view of an exemplary configuration of a piezoelectric module of FIG. 3 according to exemplary embodiments of the present invention. FIG. 5 including images (a) and (b) are conceptual diagrams illustrating a change in state according to a voltage applied to the piezoelectric module of FIG. 4 according to exemplary embodiments of the present invention. FIG. 6 illustrates an example in which operation voltages are applied to the piezoelectric module of FIG. 3 according to exemplary embodiments of the present invention. And FIG. 7 illustrates a conceptual diagram of a signal selection unit of FIG. 3 according to exemplary embodiments of the present invention.

Referring to FIG. 3 to FIG. 7, an antenna system 10 of a terminal 1 according to exemplary embodiments of the present invention includes a piezoelectric module 100, a control unit 300, and a voltage control unit 500. The antenna system 10 may further include a signal selection unit 700, a signal modulation unit 900, a frequency conversion unit 101 and a storage unit 501.

The terminal 1 and the antenna system 10 including the piezoelectric module 100, the control unit 300, the voltage control unit 500 the signal selection unit 700, the signal modulation unit 900, the frequency conversion unit 101 and the storage unit 501 are associated with and may include any of various memory or storage media for storing software, program instructions, data files, data structures, and the like, and are associated with and may also include any of various processors, computers or application specific integrated circuits (ASICs) for example, to implement various operations for using a piezoelectric module as an antenna, such as for antenna system 10 including piezoelectric module 100 in terminal 1, as described herein.

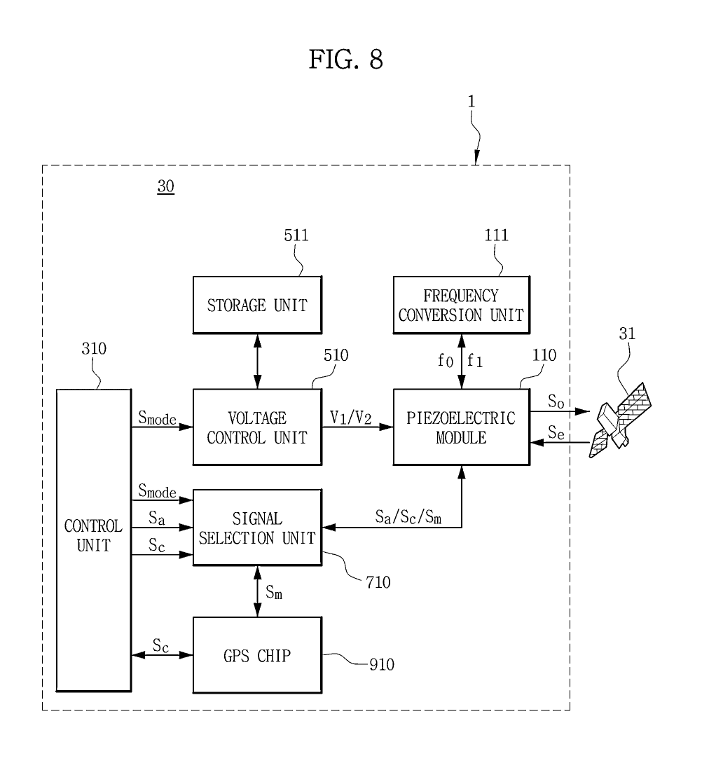

Likewise, terminal 1 including the antenna systems 30, 50, 70 and 90 of FIG. 8 to FIG. 11, respectively, including the piezoelectric modules 110, 130, 150 and 170, the control units 310, 330, 350 and 370, the voltage control units 510, 530, 550, and 570, the signal selection units 710, 730, 750, and 770, the Global Positioning System (GPS) chip 910, the Bluetooth chip 930, the WiFi chip 950, the NFC chip 970, the frequency conversion units 111, 131, 151 and 171, and the storage units 511, 531, 551 and 571, are associated with and may include any of various memory or storage media for storing software, program instructions, data files, data structures, and the like, and are associated with and may also include any of various processors, computers or application specific integrated circuits (ASICs) for example, to implement various operations for using a piezoelectric module as an antenna, such as for antenna system 10 including piezoelectric module 100 in terminal 1, as described herein.

And, although the antenna systems 10, 30, 50, 70 and 90 of terminal 1 may be described as separate units, processors, memories, modules or components, aspects are not limited thereto such that each of the units, processors, memories, modules or components may be combined with any one or more units, processors, memories, modules or components, for example, and should therefore should not be construed in a limiting sense.

Also, the software, media and program instructions as may be included in or used by the antenna systems 10, 30, 50, 70 and 90 of the terminal 1 may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

Referring to FIG. 3, the antenna system 10 may be mounted in or connected to the terminal 1 or may be an antenna itself. Examples of the terminal 1 may include mobile terminals such as smartphones, tablet computers, netbooks, personal digital assistants (PDA), portable media players (PMP), the PlayStation Portable (PSP), MP3 players, e-book readers, navigation systems, digital cameras, electronic dictionaries, and electronic watches, all electronic devices such as desktop computers, smart TVs, corded and cordless telephones, and door locks, for example.

The piezoelectric module 100 includes a piezoelectric element. The piezoelectric element is referred to as an element having properties in which a potential difference is generated by electric polarization when an external force is exerted and, on the other hand, deformation or stress occurs when a voltage is applied, that is, a piezoelectric effect. Examples of the piezoelectric element include crystals, tourmaline, Rochelle salt, barium titanate (BaTiO₃), ammonium dihydrogen phosphate (NH₄H₂PO₄), and artificial ceramic (PZT).

The piezoelectric module 100 may operate as a speaker or a motor and may simultaneously, or at approximately the same time, operate as an antenna, for example, according to exemplary embodiments. The operation of the piezoelectric module 100 is determined by the control unit 300 or according to an external signal, and different operations may be simultaneously, or at approximately the same time, performed or a single operation may be selectively performed. Hereinafter, the operation and configuration of the piezoelectric module 100 will be described in relation to where the piezoelectric module 100 operates as a speaker.

Referring to FIG. 4, the piezoelectric module 100 includes a piezoelectric element 11, a first electrode 13 and a second electrode 15 which are respectively formed at the upper portion and the lower portion of the piezoelectric element 11, and a vibration plate 17, and may further include a coating agent 12 that insulates the piezoelectric module 100 from the outside and is adhered to the vibration plate 17.

The piezoelectric element 11 may be formed of a single layer or multiple layers. In a case where the piezoelectric element 11 has multiple layers, the first electrode 13 and the second electrode 15 are formed in each layer of the piezoelectric element 11. The first electrode 13 and the second electrode 15 respectively act as a positive (+) terminal and a negative (−) terminal, or vice versa, and the electrodes 13 and 15 may include at least one of platinum (Pt), titanium (Ti), and silver (Ag), for example.

The piezoelectric effect changes a mechanical change into an electrical change, and in a case where a compressive force or a tensile force is exerted on the piezoelectric element 11 from the outside, (+) charges and (−) charges move in the opposite directions, thereby generating a voltage according to a potential difference.

On the other hand, the inverse piezoelectric effect changes an electric change into a mechanical change, and in a case where a (+) voltage and a (−) voltage are respectively applied to the upper portion and the lower portion of the piezoelectric element 11, the piezoelectric element 11 contracts or relaxes. Therefore, as illustrated in FIG. 5, in a case where alternating current voltages, such as from voltage source 14, are respectively applied to the first electrode 13 and the second electrode 15 of the piezoelectric element 11, the piezoelectric element 11 repeats contraction and relaxation, such as illustrated in images (a) and (b) of FIG. 5, for example.

As the contraction and relaxation of the piezoelectric element 11 are repeated, the piezoelectric module 100 vibrates and generates a predetermined, or reference, frequency. A fundamental frequency generated by the piezoelectric module 100 varies depending on the magnitude of the applied voltage. In exemplary embodiments, by controlling such a fundamental frequency, the piezoelectric module 100 is able to perform various operations, such as for use as a speaker, a motor or an antenna, for example.

The control unit 300 determines the operation mode of the piezoelectric module 100. The control unit 300, such as a processor, determines the operation mode on the basis of execution of an application in the terminal 1, a signal input by a user, and/or an external signal Se received by the terminal 1. The control unit 300 notifies the voltage control unit 500 of the determined operation mode through a mode signal Smode. In the case where the antenna system 10 further includes the signal selection unit 700, the control unit 300 may notify the signal selection unit 700 of the determined operation mode.

The operation mode of the piezoelectric module 100 includes a piezoelectric mode and an antenna mode. The piezoelectric mode is a mode in which the piezoelectric module 100 operates with its corresponding function or functions and may include a speaker mode of operating as a speaker and a motor mode of operating as a motor.

Specifically, in a case where the piezoelectric module 100 is a piezoelectric speaker, the piezoelectric mode may be the speaker mode of operating the piezoelectric module 100 as a speaker, and in a case where the piezoelectric module 100 is a piezoelectric motor, the piezoelectric mode may be the motor mode of operating the piezoelectric module 100 as a motor. In addition, in a case where the piezoelectric module 100 is able to operate as both the piezoelectric speaker and the piezoelectric motor, the piezoelectric mode may include both the speaker mode and the motor mode, for example. Furthermore, the piezoelectric mode may further include another mode or modes in which the piezoelectric module 100 is able to operate, according to exemplary embodiments.

The antenna mode of the piezoelectric module 100 refers to a mode in which the piezoelectric module 100 operates as the antenna of the terminal 1 and may include, and may alternately operate in, a plurality of antenna modes including, for example, a main antenna mode in which the piezoelectric module 100 operates as a main antenna of the terminal 1, an NFC antenna mode in which the piezoelectric module 100 operates as an NFC antenna of the terminal 1, a WiFi antenna mode in which the piezoelectric module 100 operates as a WiFi antenna of the terminal 1, a GPS antenna mode in which the piezoelectric module 100 operates as a GPS antenna of the terminal 1, and a Bluetooth antenna mode in which the piezoelectric module 100 operates as a Bluetooth antenna of the terminal 1.

For example, in a case where the user of the terminal 1 executes a WiFi function on the terminal 1 while the piezoelectric module 100 operates in the speaker mode, the control unit 300 may provide the mode signal Smode changed to the WiFi antenna mode to the voltage control unit 500 and the signal section unit 700. Otherwise, in a case where an NFC signal received from an external NFC reader is received, or the user executes an NFC function on the terminal 1 (such as, for example, an application execution and the like), the control unit 300 may provide the mode signal Smode changed to the NFC antenna mode to the voltage control unit 500 and the signal selection unit 700.

In a case where the antenna mode of the piezoelectric module 100 is ended, the control unit 300 may change again the operation mode of the piezoelectric module 100 to the piezoelectric mode operated previously and may provide the mode signal Smode changed according to the previously operated piezoelectric mode, or provide the Smode signal of another operation mode, to the voltage control unit 500 and the signal selection unit 700, according to exemplary embodiments.

In addition, the control unit 300 outputs various signals according to the operation mode of the piezoelectric module 100. The signals may include an audio signal Sa, a communication signal Sc, and the like, such as where the piezoelectric module 100 is operating as a piezoelectric speaker. The output audio signal Sa may be provided to the piezoelectric module 100 through the signal selection unit 700 or may be directly provided to the piezoelectric module 100. Similarly, the output communication signal Sc may be provided to the piezoelectric module 100 through the signal selection unit 700 or the signal modulation unit 900 or may be directly provided to the piezoelectric module 100, for example.

In the case where the piezoelectric module 100 is operated as a piezoelectric motor, the control unit 300 may output a mode signal Smode that corresponds to a necessary, or appropriate, signal to operate the piezoelectric module 100 as a piezoelectric motor, and may also output other mode signals Smode, such as corresponding to the communication signal Sc, and the like, instead of, or in addition to, the audio signal Sa, for example.

The voltage control unit 500 applies an operation voltage that is set to cause the piezoelectric module 100 to operate in the operation mode determined by the control unit 300. In the case where the operation mode is the piezoelectric mode, a first operation voltage V1 that generates an operation frequency at which the piezoelectric module 100 is able to operate with its corresponding function is applied. For example, in the case where the piezoelectric module 100 is operated as the piezoelectric speaker, the piezoelectric module 100 operates as the speaker in the piezoelectric mode (speaker mode). Therefore, the first operation voltage V1 is a voltage (V) that generates an operation frequency at which the piezoelectric module 100 is able to operate as the speaker.

In addition, in the case where the operation mode of the piezoelectric module 100 is the antenna mode, a second operation voltage V2 that generates an operation frequency at which the piezoelectric module 100 is able to operate in the antenna mode is applied to the piezoelectric module 100, such as to the piezoelectric element 11.

For example, in the case of the speaker mode, the voltage control unit 500 applies the first operation voltage V1 to the piezoelectric module 100, and in a case of a change from the speaker mode to the antenna mode, applies the second operation voltage V2 instead of the first operation voltage V1 to the piezoelectric module 100. Here, it is described that the first operation voltage V1 and the second operation voltage V2 are applied according to the operation modes. However, two or more operation voltages may also be applied to the piezoelectric module 100 according to the corresponding two or more operation modes, according to exemplary embodiments, for example.

In addition, the voltage control unit 500 may cause the piezoelectric module 100 to simultaneously, or at approximately the same time, implement operation of the piezoelectric module 100 in two or more operation modes by controlling the first operation voltage V1 and the second operation voltage V2 with time, such as under control of the control unit 300, for example.

Referring to FIG. 6, the voltage control unit 500 may alternately apply the first operation voltage V1 and the second operation voltage V2 in separate time slots, illustrated by the time slot sections s1 and s2, for example, according to the application of the mode signal Smode of the control unit 300. Therefore, the first operation voltage V1 and the second operation voltage V2 may be applied in time slot sections that do not overlap each other, such as time slot sections s1 for the first operation voltage V1 and time slot sections s2 for the second operation voltage S2, as illustrated in FIG. 6, according to exemplary embodiments, for example.

In this case, the piezoelectric module 100 may simultaneously, or at approximately the same time, implement two or more operation modes as the two or more operation voltages are applied, and by causing the time slot sections, such as time slot section s1 and s2, to be relatively very short, the user of the terminal 1 may not recognize that two or more operation modes are simultaneously performed, or performed at about the same time, by the piezoelectric module 100 of terminal 1.

The voltage control unit 500 may further include a storage unit 501, such as a memory, that stores information regarding the operation voltages V1, V2, V3, etc., corresponding to the operation modes. The storage unit 501 may store each operation voltage value and a fundamental frequency generated by the piezoelectric module 100 to correspond to the operation voltage value in the form of a lookup table. Data of the lookup table may be controlled in software, hardware or firmware, such as by a processor, for example. Table 1 below is an example of the lookup table stored by the storage unit 501.

TABLE 1

| V-tune | Piezoelectric Frequency Range | |
|---|---|---|
| 0 V | 0 | Hz |
| 0.1 V | 500 | Hz |
| 0.2 V | 1.0 | kHz |
| 0.3 V | 1.5 | kHz |
| 0.4 V | 2.0 | kHz |
| 0.5 V | 2.5 | kHz |
| 0.6 V | 3.0 | kHz |
| 0.7 V | 3.5 | kHz |
| 0.8 V | 4.0 | kHz |
| 0.9 V | 4.5 | kHz |
| 1.0 V | 5.0 | kHz |
| 1.1 V | 5.5 | kHz |
| 1.2 V | 6.0 | kHz |
| 1.3 V | 6.5 | kHz |
| 1.4 V | 7.0 | kHz |
| 1.5 V | 7.5 | kHz |
| 1.6 V | 8.0 | kHz |
| 1.7 V | 8.5 | kHz |
| 1.8 V | 9.0 | kHz |
| 1.9 V | 9.5 | kHz |
| 2.0 V | 10.0 | kHz |
| 2.1 V | 10.5 | kHz |
| 2.2 V | 11.5 | kHz |
| 2.3 V | 12.0 kHz −> Bluetooth resonance | |
| 2.4 V | 12.5 | kHz |
| 2.5 V | 13.0 | kHz |
| 2.6 V | 13.5 kHz −> NFC resonance | |
| 2.7 V | 14.0 | kHz |
| 2.8 V | 14.5 | kHz |
| 2.9 V | 15.0 | kHz |
| 3.0 V | 15.5 kHz −> GPS resonance | |
| 3.1 V | 16.0 | kHz |
| 3.2 V | 16.5 | kHz |
| 3.3 V | 17.0 | kHz |
| 3.4 V | 17.5 | kHz |
| 3.5 V | 18.0 | kHz |
| 3.6 V | 18.5 | kHz |
| 3.7 V | 19.0 | kHz |
| 3.8 V | 19.5 | kHz |

| | |
|---|---|
| 3.9 V | 20.0 kHz −> WiFi resonance |

Referring to Table 1, in a case where the voltage control unit 500 applies an operation voltage of 2.6 V to the piezoelectric module 100, the piezoelectric module 100 generates a fundamental frequency f0 of 13.5 kHz. The fundamental frequency f0 of 13.5 kHz is the base of an operation frequency f1 of the NFC antenna mode of the piezoelectric module 100, for example.

The storage unit 501 may also store, instead of, or in addition to, the fundamental frequency generated by the piezoelectric module 100, operation modes and an operation voltage value according to each of the operation modes in the form of a lookup table, according to exemplary embodiments, for example.

The piezoelectric module 100 may include a frequency conversion unit 101 that converts the generated fundamental frequency f0 into the operation frequency f1 corresponding to each of the operation modes. The frequency conversion unit 101 may include a nonlinear element such as a diode, for example. The frequency conversion unit 101 may also include a frequency multiplier. The frequency multiplier has a configuration of multiplying a frequency by a multiple of n to be increased to a target frequency. The multiple (n) for the multiplication may be an integer multiple, but is not limited thereto and, therefore, should not be construed in a limiting sense. Also, for example, a multiplication in units of decimal points may also be s achieved to adjust the operation frequency of the piezoelectric module 100, according to exemplary embodiments.

The frequency conversion unit 101 may include a mixer (particularly, an up mixer). The mixer mixes a carrier wave and a particular frequency to be increased or decreased to a target frequency while maintaining signal characteristics. Hereinafter, exemplary embodiments in which the frequency conversion unit 101 includes the frequency multiplier, that is, exemplary embodiments in which the fundamental frequency is multiplied n times (not limited to an integer) to generate an operation frequency of the piezoelectric module 100 will be described.

For example, with reference to also to Table 1, the frequency conversion unit 101 is multiplies a fundamental frequency f0 of 13.5 kilohertz (kHz) generated by the piezoelectric module 100 1000 times so as to be moved to an operation frequency f1 of 13.5 megahertz (MHz). The operation frequency f1 of 13.5 MHz is a resonant frequency that approaches the frequency band (13.56 MHz) of the NFC antenna mode of the piezoelectric module 100. Accordingly, the piezoelectric module 100 vibrates at the operation frequency f1 of 13.5 MHz. Therefore, the piezoelectric module 100 operates in the NFC antenna mode and thus may transmit an NFC signal to the outside of the terminal 1 or receive an NFC signal from an external NFC device.

The signal selection unit 700 provides a signal or signals, such as a single signal, that is obtained by filtering the signals provided from the control unit 300 according to the operation mode to the piezoelectric module 100. The signal selection unit 700 acts as a diplexer and outputs a signal or signals, which is typically only a single signal, according to the operation mode to the piezoelectric module 100, for example.

As illustrated in FIG. 7, the signal selection unit 700 may include a plurality of filters 701, 703, 705 to pass only those signals corresponding to the operation mode or operation modes of the piezoelectric module 100, such as those necessary, or appropriate, signals from a plurality of signals, for the corresponding operation mode or modes. The filters 701, 703, 705, etc., may include at least one band-pass filter, for example. In addition, the signal selection unit 700 may receive the mode signal Smode from the control unit 300 and switch the filters 701, 703, 705 according to each of the operation mode or operation modes corresponding to the mode signal or mode signals S mode, for example, according to exemplary embodiments.

The signal selection unit 700 may function as a diplex filter, for example. Specifically, the signal selection unit 700 may filter the signals provided from the control unit 300 so as to be provided to the piezoelectric module 100, and on the other hand, may filter signals provided from the piezoelectric module 100 so as to be provided to the control unit 300, according to exemplary embodiments.

In the case where the piezoelectric module 100 operates in the speaker mode, the signal selection unit 700 may pass the audio signal Sa received from the control unit 300 so as to be provided to the piezoelectric module 100. On the other hand, in the case where the piezoelectric module 100 operates in the antenna mode, the signal selection unit 700 passes the communication signal Sc received from the control unit 300 so as to be provided to the piezoelectric module 100. Accordingly, interference between signals may be avoided, according to exemplary embodiments.

For example, the signal selection unit 700 may include a low-pass filter and a high-pass filter, perform low-pass filtering of signals input from the control unit 300 in the case where the piezoelectric module 100 operates in the speaker mode or the motor mode, and perform high-pass filtering of signals input from the control unit 300 in the case where the piezoelectric module 100 operates in the antenna mode. This is because, generally, the audio signal Sa is typically a low-band signal, the motor mode signal is typically a low-band signal, and the communication signal Sc is a high-band signal, but use of low band signals or high band signals as corresponding to audio signals, to motor signals or to communication signals, should not be construed in a limiting sense.

In exemplary embodiments, the control unit 300 may also determine the operation mode of the piezoelectric module 100 and output only a signal of the determined operation mode. In this case, for example, the antenna system 10 may not include the signal selection unit 700, and the signal output from the control unit 300 may be directly provided to the piezoelectric module 100, according to exemplary embodiments.

The signal modulation unit 900 may modulate the communication signal Sc provided from the control unit 300 according to each of the antenna modes so as to be provided to the signal selection unit 700 or be directly provided to the piezoelectric module 100. The signal modulated by the signal modulation unit 900 is referred to as a modulation signal Sm.

The signal modulation unit 900 modulates the communication signal Sc into a modulation signal Sm appropriate for the antenna mode of the one or more antenna modes of the terminal 1 according to each of communication environments including the main antenna mode, the NFC antenna mode, the WiFi antenna mode, the GPS antenna mode, and the Bluetooth antenna mode, and the like, for example. The modulation method may be radio frequency (RF) modulation.

For example, when the piezoelectric module 100 is in the NFC antenna mode, the signal modulation unit 900 has a function of an NFC chip, and when the piezoelectric module 100 is in the WiFi antenna mode, the signal modulation unit 900 may have a function of a WiFi chip. Similarly, when the piezoelectric module 100 is in the GPS antenna mode, the signal modulation unit 900 has a function of a GPS chip, and when the piezoelectric module 100 is in the Bluetooth antenna mode, the signal modulation unit 900 may have a function of a Bluetooth chip.

Since the signal modulation unit 900 provides the modulation signal Sm appropriate for each of the antenna operation modes of the piezoelectric module 100 to the piezoelectric module 100, the piezoelectric module 100 may operate as various antennas, according to exemplary embodiments, for example. Also, according to exemplary embodiments, the piezoelectric module 100 may operate only in a single antenna mode. Hereinafter, exemplary embodiments in which the piezoelectric module operates as each of the various antennas in the corresponding antenna mode or modes will be described with reference to FIG. 8 to FIG. 11.

FIG. 8 illustrates a block diagram of a GPS antenna system of a terminal according to exemplary embodiments of the present invention.

Referring to FIG. 8, a GPS antenna system 30 of the terminal 1 according to exemplary embodiments includes the piezoelectric module 110, the control unit 310 and the voltage control unit 510. The antenna system 30 may further include the signal selection unit 710 or the GPS chip 910, according to exemplary embodiments.

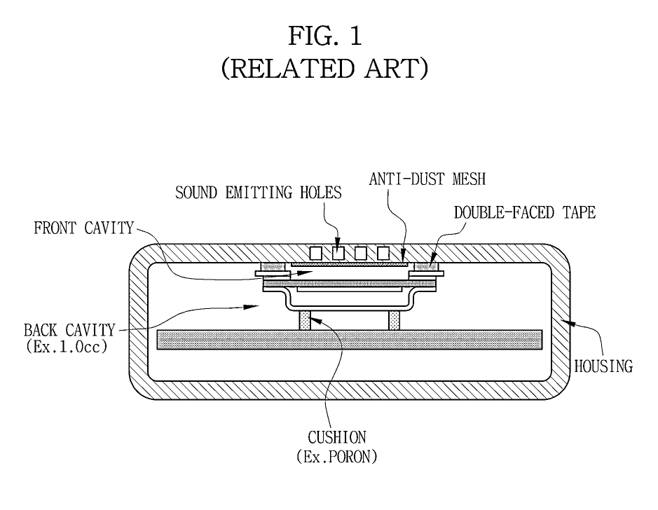

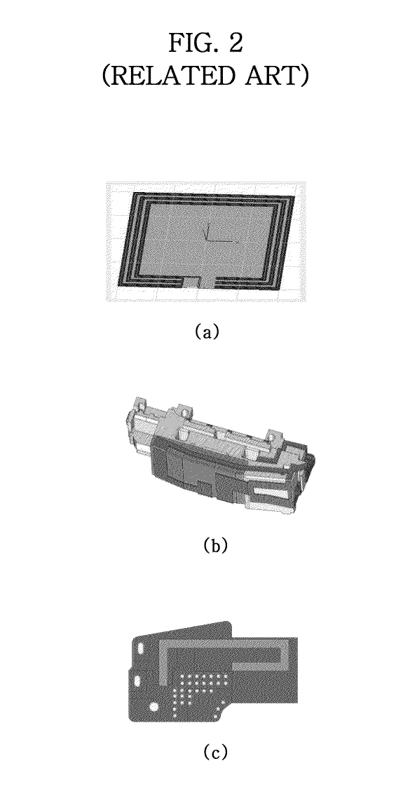

The GPS antenna system 30 of terminal 1 of FIG. 8 according to exemplary embodiments is an antenna system that embodies the antenna system 10 of FIG. 1 and is substantially the same as or similar to the antenna system 10 of FIG. 1. Therefore, unless described otherwise, corresponding components, units and modules of the GPS antenna system 30 operate in a similar manner as described with respect to those corresponding components, units and modules of antenna system 10, and descriptions of the same or similar components as those of the antenna system 10 of FIG. 1 will be simplified or omitted.

The piezoelectric module 110 may operate as a speaker and/or a motor and may simultaneously, or at approximately the same time, operate as a GPS antenna. The piezoelectric module 110 may include a frequency conversion unit 111 that converts a fundamental frequency f0 into an operation frequency, such as for the piezoelectric module 110 to operate as a GPS antenna, for example.

The piezoelectric module 110 normally operates as the speaker and/or the motor in the terminal 1, and in a case where the user executes a navigation system on the terminal 1 or executes an application associated with a GPS operation, such as Find Friends, the control unit 310 recognizes the execution of the GPS application or operation.

In the case where the control unit 310 recognizes the execution of GPS application or operation, the control unit 310 determines the operation mode of the piezoelectric module 110 as the GPS antenna mode. The control unit 310 notifies the voltage control unit 510 of the determined GPS antenna mode through a mode signal Smode. In the case where the antenna system 30 further includes the signal selection unit 710, the control unit 310 may also notify the signal selection unit 710 of the determined operation mode as the GPS antenna mode, according to exemplary embodiments.

Simultaneously, or at approximately the same time, with the generating and providing of the mode signal Smode by the control unit 310, or subsequently, the control unit 310 may provide the communication signal Sc to the GPS chip 910. The GPS chip 910 may modulate the communication signal Sc to a signal according to the GPS antenna mode and provide the modulation signal Sm to the signal selection unit 710 or may directly provide the modulation signal Sm to the piezoelectric module 110, for example, according to exemplary embodiments.

The signal selection unit 710 may include a plurality of filters to pass only those signals corresponding to the operation mode or operation modes of the piezoelectric module 110, such as those necessary, or appropriate, signals from a plurality of signals for the corresponding operation mode or modes. For example, where the piezoelectric module 110 operates in the speaker mode, the signal selection unit 710 may pass an audio signal Sa received from the control unit 310 so as to be provided to the piezoelectric module 110. On the other hand, in the case where the piezoelectric module 110 operates in the GPS antenna mode, the signal selection unit 710 may pass the modulation signal Sm corresponding to the GPS antenna mode so as to be provided to the piezoelectric module 110, according to exemplary embodiments.

The voltage control unit 510 normally, or typically, provides a first operation voltage V1 according to the speaker mode or the motor mode of the piezoelectric module 110 to the piezoelectric module 110 and changes the operation voltage in the case of receiving the mode signal Smode from the control unit 310, such as for the GPS antenna mode, for example.

Specifically, for example, referring to Table 1, the voltage control unit 510 applies a second operation voltage V2 (of, for example, 3V) corresponding to 15.5 kHz which is the fundamental frequency f0 of the GPS antenna mode set in advance to the piezoelectric module 110. The voltage control unit 510 may include a storage unit 511 that stores information regarding the second operation voltage V2 corresponding to the fundamental frequency f0, according to exemplary embodiments.

The piezoelectric module 110 vibrates at the fundamental frequency f0 of 15.5 kHz according to the second operation voltage V2 of 3 V. And, in order to generate an operation frequency f1 in the satellite frequency band, the frequency conversion unit 111 may multiply, for example, the fundamental frequency f0 of 15.5 kHz 101640 times to generate a frequency of 1575.42 MHz.

The piezoelectric module 110 causes the modulation signal Sm provided from the control unit 310 to be carried by a carrier wave having the frequency of 1575.42 MHz and radiates an output signal So corresponding to the GPS antenna mode, such as to be received by a GPS satellite 31.

In addition, the piezoelectric module 110 may receive a signal having the frequency of 1575.42 MHz from the GPS satellite 31. The received signal may be transmitted to the control unit 310 through the signal selection unit 710 and the GPS chip 910. The received signal Se typically has a very low power level due to an effect of attenuation and noise and thus may need to be amplified. The signal is received in the terminal 1 from the outside while typically including a relative large amount of noise, and thus an amplification function of minimizing noise is typically necessary for the received signal.

In this regard, the GPS chip 910 typically may include a GPS low noise amplifier (LNA) designed by catching an operation point and a matching point so as to reduce the noise figure (NF) of the received signal, thereby normally, or typically, controlling an NF value between 1.5 and 2.5. The GPS LNA is a basic amplifier among RF amplifiers and may be easily designed, such as by those skilled in the art. Also, in order to enhance low noise characteristics, the number of transistors having a low noise figure and thermal noise elements such as resistors, may be reduced so as to reduce current in use of the low noise amplifier, for example.

According to exemplary embodiments, the frequency conversion unit 111 multiplies, for example, the fundamental frequency f0 of 15.5 kHz 101640 times in order to generate the operation frequency f1 in the satellite frequency band, and may also perform a multiplication to obtain a necessary, or appropriate, operation frequency f1 according to applications or operations of the terminal 1. In addition, in order to generate an operation frequency f2 in the military satellite frequency band, for example, the piezoelectric module f0 of 15.5 kHz may be multiplied 79200 times to generate a frequency of 1227.60 MHz. Table 2 below illustrates an example of data regarding operation frequencies generated by multiplying the fundamental frequency f0.

TABLE 2

| | | | |
|---|---|---|---|
| Fundamental frequency | f0 | f0 | 15.5 kHz |
| Satellite signal (carrier wave) | f1 | f0*101640 | 1575.42 MHz |
| | f2 | f0*79200 | 1227.60 MHz |

Furthermore, the frequency conversion unit 111 generates corresponding frequencies according to various GPS systems in world-wide use, such as Wideband GPS systems and Global Navigation Satellite Systems (GLONASS) typically without significant limitations to the commercial satellite and the military satellite applications, thereby effectively providing active/passive antennas for most GPS systems, for example.

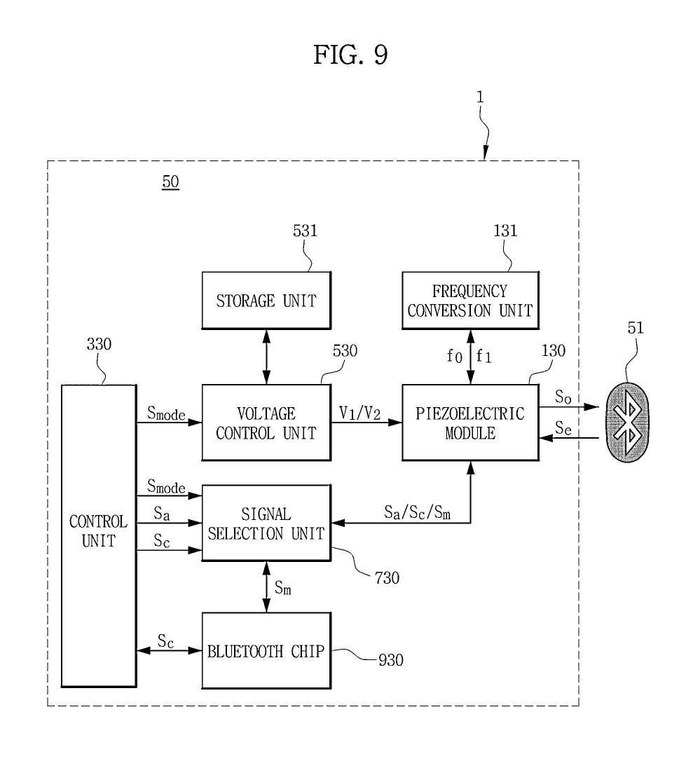

FIG. 9 is a block diagram of a Bluetooth antenna system of a terminal according to exemplary embodiments of the present invention.

Referring to FIG. 9, the Bluetooth antenna system 50 of terminal 1 according exemplary embodiments is substantially the same as or similar to the GPS antenna system 30 of FIG. 8 except for the Bluetooth chip 930. Therefore, unless described otherwise, corresponding components, units and modules of the Bluetooth antenna system 50 operate in a similar manner as described with respect to those corresponding components, units and modules of antenna system 10 of FIG. 1 and GPS antenna system 30 of FIG. 8, and repeated descriptions of the same or similar components as those of the antenna system 30 of FIG. 8 or the antenna system 10 of FIG. 1 will be simplified or omitted.

The piezoelectric module 130 may operate as a speaker or a motor in the terminal 1 and may simultaneously, or at approximately the same time, operate as a Bluetooth antenna in the terminal 1. The piezoelectric module 130 normally, or typically, operates as the speaker or the motor, and in a case where the user executes a Bluetooth operation or application function on the terminal 1 or executes an application associated with a Bluetooth operation, the control unit 330 recognizes the execution of the Bluetooth operation or application corresponding to the Bluetooth antenna mode, according to exemplary embodiments.

In the case where the control unit 330 recognizes the execution of the Bluetooth operation or application, the control unit 330 determines the operation mode of the piezoelectric module 130 as the Bluetooth antenna mode. The control unit 330 notifies the voltage control unit 530 of the determined Bluetooth antenna mode through a corresponding mode signal Smode. In the case where the Bluetooth antenna system 50 further includes a signal selection unit 730, the control unit 330 may also notify the signal selection unit 730 of the determined operation mode as the Bluetooth antenna mode.

Simultaneously with, or at approximately the same time as, the control unit 330 generates and provides the mode signal Smode for the Bluetooth antenna mode, or subsequently, the control unit 330 may provide a communication signal Sc to the Bluetooth chip 930. The Bluetooth chip 930 may modulate the communication signal Sc to a signal according to the Bluetooth antenna mode and provide the modulation signal Sm to the signal selection unit 730 or directly provide the modulation signal Sm to the piezoelectric module 130 to operate in the Bluetooth antenna mode, for example, according to exemplary embodiments.

The voltage control unit 530 applies, referring also to Table 1, a second operation voltage V2 (of, for example, 2.3 V) corresponding to 12 kHz which is the fundamental frequency f0 of the Bluetooth antenna mode set in advance to the piezoelectric module 130. The voltage control unit 530 may include a storage unit 531 that stores information regarding the second operation voltage V2 corresponding to the fundamental frequency f0, for example, according to exemplary embodiments.

The piezoelectric module 130 vibrates at the fundamental frequency f0 of 12 kHz according to the second operation voltage V2 of 2.3 V. And, in order to generate an operation frequency f1 in the Bluetooth frequency band, the frequency conversion unit 131 of the piezoelectric module 130 multiplies the fundamental frequency f0 of 12 kHz, according to exemplary embodiments.

Since the Bluetooth frequency band is typically 2.4 GHz to 2.5 GHz, the frequency conversion unit 131 may multiply, for example, the fundamental frequency f0 of 12 kHz 200000 times to 208333 times to generate the operation frequency f1 in the Bluetooth frequency band.

The piezoelectric module 130 causes the modulation signal Sm provided from the control unit 330 to be carried by a carrier wave having a frequency of typically 2.4 GHz to 2.5 GHz and radiates an output signal So from the terminal 1 to a Bluetooth device 51.

In addition, the piezoelectric module 130 may receive a signal having a frequency of typically 2.4 GHz to 2.5 GHz from the external Bluetooth device 51. The received signal may be transmitted to the control unit 330 through the signal selection unit 730 and the Bluetooth chip 930 for a Bluetooth operation or application in the terminal 1.

According to exemplary embodiments, in order to generate the operation frequency f1 in the Bluetooth frequency band, the frequency conversion unit 131 may multiply the fundamental frequency f0 of 12 kHz to obtain a necessary, or appropriate, operation frequency f1 in the Bluetooth frequency band according to the corresponding Bluetooth application or applications. Therefore, the frequency conversion unit 131 may flexibly multiply the fundamental frequency depending on Bluetooth frequency bands according to regional settings, for example. Table 3 below illustrates an example of data regarding operation frequencies generated by multiplying the fundamental frequency f0.

TABLE 3

| | | | | |
|---|---|---|---|---|
| Fundamental frequency | f0 | f0 | 12 | kHz |
| Bluetooth signal (carrier wave) | f1 | f0*200000 | 2.4 | GHz |
| | f2 | f0*208333 | 2.5 | GHz |

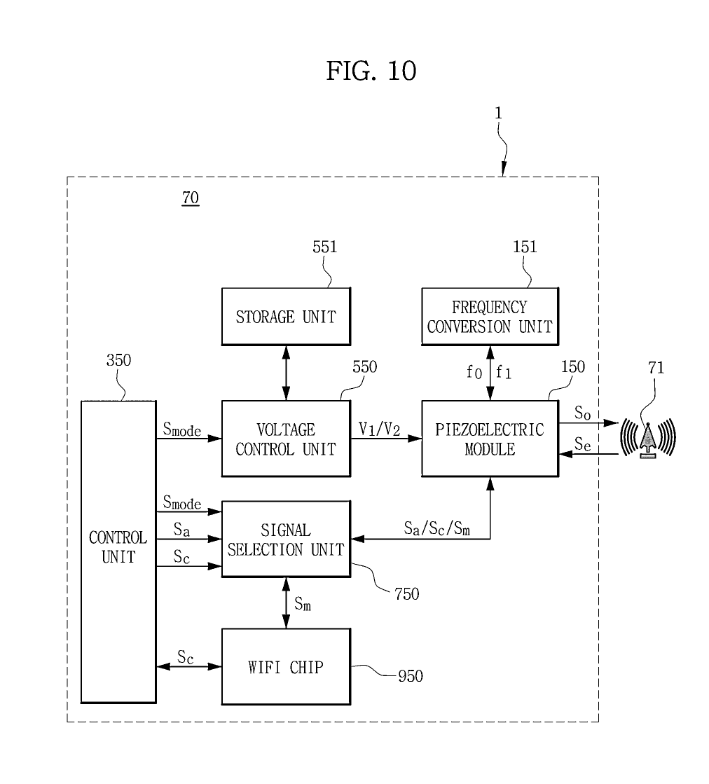

FIG. 10 is a block diagram of a WiFi antenna system of a terminal according to exemplary embodiments of the present invention.

Referring to FIG. 10, a WiFi antenna system 70 of terminal 1 according to exemplary embodiments is substantially the same as or similar to the GPS antenna system 30 of FIG. 8 except for a WiFi chip 950. Therefore, unless described otherwise, corresponding components, units and modules of the WiFi antenna system 70 operate in a similar manner as described with respect to those corresponding components, units and modules of antenna system 10 of FIG. 1 and GPS antenna system 30 of FIG. 8, and repeated descriptions of the same or similar components as those of the GPS antenna system 30 of FIG. 8 or the antenna system 10 of FIG. 1 will be simplified or omitted.

The piezoelectric module 150 in the WiFi antenna system 70 may operate as a speaker or a motor and may simultaneously, or at approximately the same time, operate as a WiFi antenna in a WiFi antenna mode. The piezoelectric module 150 normally operates as the speaker or the motor, and in a case where the user executes a WiFi application function or operation on the terminal 1 or executes an application associated with a WiFi operation, the control unit 350 recognizes the execution of the WiFi application or operation corresponding to the WiFi antenna mode.

In the case where the control unit 350 recognizes the execution of the WiFi application or operation, the control unit 350 determines the operation mode of the piezoelectric module 150 as the WiFi antenna mode. The control unit 350 notifies the voltage control unit 550 of the determined WiFi antenna mode through a mode signal Smode corresponding to the WiFi antenna mode. In the case where the antenna system 70 further includes a signal selection unit 750, the control unit 350 may also notify the signal selection unit 750 of the determined operation mode as the WiFi antenna mode, for example, according to exemplary embodiments.

Simultaneously with, or at approximately the same time, the control unit 350 generates or provides the mode signal Smode corresponding to the WiFi antenna mode, or subsequently, the control unit 350 may provide a communication signal Sc to the WiFi chip 950 corresponding to the WiFi antenna mode. The WiFi chip 950 may modulate the communication signal Sc to a signal according to the WiFi antenna mode and provide the modulation signal Sm corresponding to the WiFi antenna mode to the signal selection unit 750 or directly provide the modulation signal Sm to the piezoelectric module 150 to operate in the WiFi antenna mode, for example, according to exemplary embodiments.

The voltage control unit 550 applies, also referring to Table 1, a second operation voltage V2 (of, for example, 3.9 V) corresponding to 20 kHz which is the fundamental frequency f0 of the WiFi antenna mode set in advance to the piezoelectric module 150, for example. The voltage control unit 550 may include a storage unit 551 that stores information regarding the second operation voltage V2 corresponding to the fundamental frequency f0 corresponding to the WiFi antenna mode, according to exemplary embodiments.

The second operation voltage V2 in the WiFi frequency band overlaps that in the Bluetooth frequency band, and thus may be set to be different from that in the case of the Bluetooth antenna mode in order to prevent or minimize the voltages from being mixed in use. And, in this regard, a frequency in a necessary, or appropriate, frequency band, such as for a WiFi frequency band, may be generated by controlling the degree of frequency multiplication, for example, according to exemplary embodiments.

The piezoelectric module 150 vibrates at the fundamental frequency f0 of 20 kHz according to the second operation voltage V2 of 3.9 V. And, in order to generate an operation frequency f1 in the WiFi frequency band, the frequency conversion unit 151 of the piezoelectric module 150 multiplies the fundamental frequency f0 of 20 kHz by a corresponding multiplier to generate the appropriate operation frequency f1 in the WiFi frequency band, for example, according to exemplary embodiments.

Since the WiFi frequency band is typically 2.4 GHz to 2.5 GHz, the frequency conversion unit 151 may multiply the fundamental frequency f0 of 20 kHz 120000 times to 125000 times, for example, to generate an operation frequency f1 in the WiFi frequency band, according to exemplary embodiments.

The piezoelectric module 150 causes the modulation signal Sm provided from the control unit 350 to be carried by a carrier wave having a frequency of typically 2.4 GHz to 2.5 GHz and radiates an output signal So from the terminal 1 to a WiFi device 71.

In addition, the piezoelectric module 150 may receive a signal having a frequency of typically 2.4 GHz to 2.5 GHz from the external WiFi device 71 (for example, an Access Point). The received signal from the external WiFi device 71 may be transmitted to the control unit 350 through the signal selection unit 750 and the WiFi chip 950, for example, according to exemplary embodiments.

According to exemplary embodiments, in order to generate the operation frequency f1 in the WiFi frequency band, the frequency conversion unit 151 may multiply the fundamental frequency f0 of 20 kHz to obtain a necessary, or appropriate, operation frequency f1 according to applications or operations corresponding to the WiFi frequency band. For example, in order to generate a frequency of typically 5 GHz to 5.7 GHz in a WiFi added frequency band, the frequency conversion unit 151 may multiply, for example, the fundamental frequency f0 of 20 kHz 250000 times to 285000 times. In addition, the frequency conversion unit 151 may flexibly multiply the fundamental frequency depending on the WiFi frequency bands according to regional settings for corresponding WiFi frequency bands, for example. Table 4 below illustrates an example of data regarding operation frequencies generated by multiplying the fundamental frequency f0 in the WiFi frequency band.

TABLE 4

| | | | | |
|---|---|---|---|---|
| Fundamental frequency | f0 | f0 | 20 | kHz |
| WiFi signal (carrier wave) | f1 | f0*120000 | 2.4 | GHz |
| | f2 | f0*125000 | 2.5 | GHz |
| | f3 | f0*250000 | 5 | GHz |
| | f4 | f0*285000 | 5.7 | GHz |

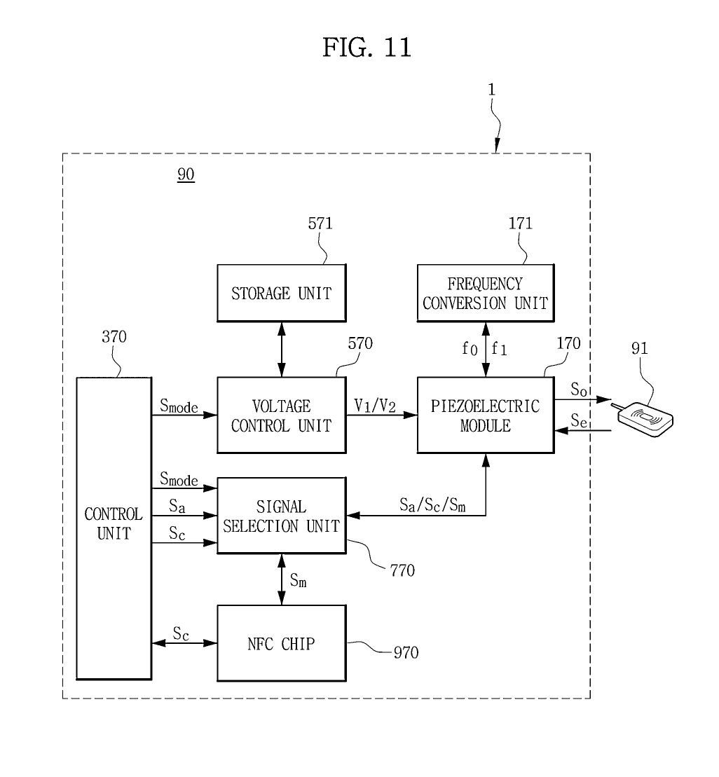

FIG. 11 illustrates a block diagram of an NFC antenna system of a terminal according to exemplary embodiments of the present invention.

Referring to FIG. 11, an NFC antenna system 90 of terminal 1 according to exemplary embodiments is substantially the same as or similar to the GPS antenna system 30 of FIG. 8 except for an NFC chip 970. Therefore, unless described otherwise, corresponding components, units and modules of the NFC antenna system 90 operate in a similar manner as described with respect to those corresponding components, units and modules of antenna system 10 of FIG. 1 and GPS antenna system 30 of FIG. 8, and repeated descriptions of the same or similar components as those of the antenna system 30 of FIG. 8 or the antenna system 10 of FIG. 1 will be simplified or omitted.

The piezoelectric module 170 may operate as a speaker and/or a motor and may simultaneously, or at approximately the same time, operate as an NFC antenna, according to exemplary embodiments. The piezoelectric module 170 normally typically operates as the speaker and/or the motor, and in a case where the user executes an NFC operation function on the terminal 1 or executes an application associated with an NFC operation, the control unit 370 recognizes the execution of the NFC operation or application as corresponding to the NFC antenna mode. Otherwise, in a case where the terminal 1 comes into contact with an external NFC reader, such as on NFC device 91, and a magnetic field is detected, the NFC chip 970 recognizes the execution of the NFC operation or application and notifies the control unit 370.

In the case where the control unit 370 recognizes the execution of the NFC operation or application or is notified thereof, the control unit 370 determines the operation mode of the piezoelectric module 170 as the NFC antenna mode. The control unit 370 notifies the voltage control unit 570 of the determined NFC antenna mode through a mode signal Smode corresponding to the NFC antenna mode. In the case where the NFC antenna system 90 further includes a signal selection unit 770, the control unit 370 may also notify the signal selection unit 770 of the determined operation mode as the NFC antenna mode, for example, according to exemplary embodiments.

Simultaneously with, or at approximately the same time as, the control unit 370 generates or provides the mode signal Smode corresponding to the NFC antenna mode, or subsequently, the control unit 370 may provide a communication signal Sc to the NFC chip 970 corresponding to the NFC antenna mode. The control unit 370 and the NFC chip 970 may communicate with each other in a single wire protocol (SWP) method, for example. The NFC chip 970 may modulate the communication signal Sc to a signal according to the NFC antenna mode and provide the modulation signal Sm corresponding to the NFC antenna mode to the signal selection unit 770 or may directly provide the modulation signal Sm to the piezoelectric module 170, according to exemplary embodiments, for example.

The voltage control unit 570 applies, referring also to Table 1, a second operation voltage V2 (of, for example, 2.6 V) corresponding to 13.5 kHz which is the fundamental frequency f0 of the NFC antenna mode set in advance to the piezoelectric module 170. The voltage control unit 570 may include a storage unit 571 that stores information regarding the second operation voltage V2 corresponding to the fundamental frequency f0 corresponding to the NFC antenna mode, according to exemplary embodiments, for example.

The piezoelectric module 170 vibrates at the fundamental frequency f0 of typically 13.5 kHz according to the second operation voltage V2 of 2.6 V in the NFC antenna mode. And, in order to generate an operation frequency f1 in the NFC frequency band, the frequency conversion unit 171 of the piezoelectric module 170 multiplies, for example, the fundamental frequency f0 of 13.5 kHz to generate the operation frequency f1 in the NFC frequency band, according to exemplary embodiments, for example.

Since the NFC frequency band is typically 13.56 MHz, the frequency conversion unit 171 may multiply the fundamental frequency f0 of 13.5 kHz, for example, 1000 times to generate a resonant frequency that approaches the operation frequency f1 in the NFC frequency band, for example, according to exemplary embodiments.

The piezoelectric module 170 causes the modulation signal Sm provided from the control unit 370 to be carried by a carrier wave having the frequency of 13.5 MHz corresponding an operation frequency f1 in the NFC frequency band and radiates an output signal So from the terminal 1 to the NFC device 91. In this case, the piezoelectric module 170 of the terminal 1 acts as the transmitter of the antenna (NFC dongle mode), according to exemplary embodiments.

In addition, the piezoelectric module 170 is supplied with power at a magnetic field intensity of typically about 1.5 A/m to about 7.5 A/m from the external NFC device 91 (for example, an NFC reader) and the piezoelectric module 170 vibrates by the received power. In this case, the NFC chip 970 recognizes execution of NFC operation or application and notifies the control unit 370, and the piezoelectric module 170 acts as the receiver of the antenna in the NFC antenna mode and receives a signal Se from the external NFC device 91 (NFC card mode).

The signal received from the external NFC device 91 is typically an analog signal and is converted into a digital signal by the NFC chip 970 so as to be transmitted to the control unit 370 of the terminal 1.

According to exemplary embodiments, in order to generate the operation frequency f1 in the NFC frequency band, the frequency conversion unit 171 may multiply the fundamental frequency f0 of typically 13.5 kHz to obtain a necessary, or appropriate, operation frequency f1 according to the corresponding NFC operations or applications. In addition, the frequency conversion unit 171 may flexibly multiply the fundamental frequency to generate the operation frequency f1 in the NFC frequency band, depending on NFC frequency bands according to regional settings corresponding to the NFC frequency bands, for example, according to exemplary embodiments.

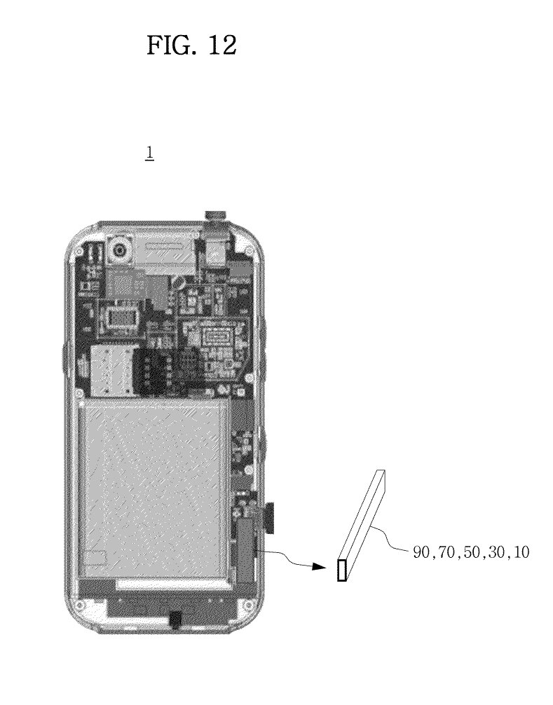

Referring to FIG. 12, an example in which the antenna systems 10, 30, 50, 70 and 90 of FIG. 3 and FIG. 8 to FIG. 11 also operate as the piezoelectric motor and are respectively mounted in a terminal 1 is illustrated, according to exemplary embodiments of the present invention.

FIG. 12 illustrates an example in which a piezoelectric module, such as the piezoelectric module 100 of antenna system 10 of FIG. 3, the piezoelectric module 110 of GPS antenna system 30 of FIG. 8, the piezoelectric module 130 of Bluetooth antenna system 50 of FIG. 9, the piezoelectric module 150 of WiFi antenna system 70 of FIG. 10, and the piezoelectric module 170 of NFC antenna system 90 of FIG. 11, is mounted in the terminal 1 where the piezoelectric module 100, 110, 130, 150, 170 or 190 operates as a motor, as well as in the corresponding antenna mode.

As illustrated in FIG. 12, according to exemplary embodiments, the piezoelectric module used as an antenna of an antenna system that is able to simultaneously, or at about the same time, operate as a piezoelectric motor (and/or a speaker) and as an antenna may be mounted in an area of the terminal 1 in which a piezoelectric motor may be typically mounted, for example. Therefore, the mounting area and volume of the terminal 1 as may be used for a motor, speaker and an antenna may be reduced, thereby promoting or contributing to a reduction in thickness of the terminal 1. Also, additional components, such as may be used for separately mounting or including a motor, speaker or an antenna in the terminal, such as the terminal 1, typically may not be necessary. And, thus mounting characteristics of components in a terminal, such as the terminal 1, may be enhanced and manufacturing cost may be reduced, according to exemplary embodiments.

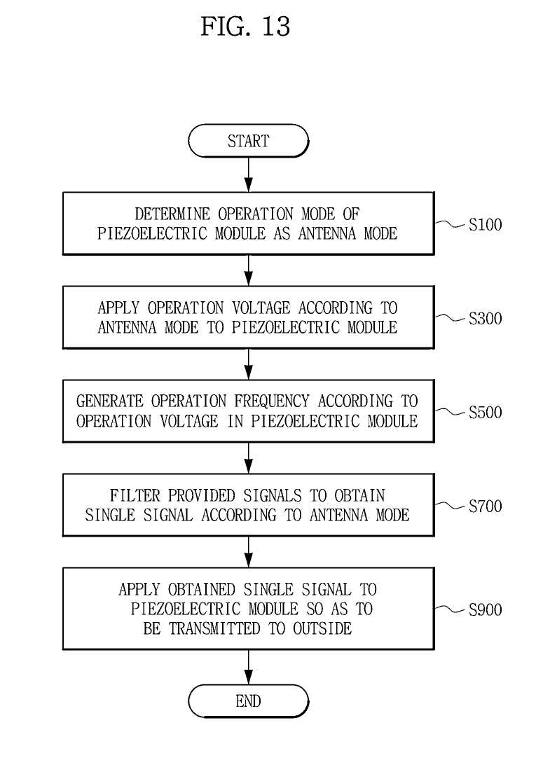

FIG. 13 is a flowchart illustrating a method for implementing an antenna using a piezoelectric module in a terminal according to exemplary embodiments of the present invention.

Referring to FIG. 13, the method for implementing an antenna using a piezoelectric module according to exemplary embodiments may be performed in substantially the same or a similar configuration as that of the antenna system 10 of the terminal of FIG. 3 and, therefore, may be also performed in a configuration same or similar to the antenna systems 30, 50, 70 and 90 of FIG. 8 to FIG. 11, for example. And, therefore, the method illustrated in FIG. 13 is described with like elements which are the same as or similar to those of the antenna system 10 of the terminal 1 of FIG. 3 are denoted by like reference numerals, and repeated descriptions will be omitted.

In the method for implementing an antenna using a piezoelectric module according to exemplary embodiments, the operation mode of the piezoelectric module, such as piezoelectric module 100, is determined by the control unit, such as control unit 300, as an antenna mode in operation S100. In a case where the antenna operation function needs, or is determined, to be used by the terminal 1, while the piezoelectric module operates in its one or more piezoelectric modes, according to exemplary embodiments, for example, an antenna mode change signal is generated by the control unit 300 in the operation S100. Such need, or determination, for the antenna operation function of the piezoelectric module 100 may arise where the control unit 300 recognizes execution of an NFC, WiFi, GPS, or Bluetooth operation function or application or recognizes contact of an external NFC reader through the signal modulation unit 900, such as the NFC chip 970. And the operation mode of the piezoelectric module 100 may be changed to the antenna mode according to the generated antenna mode change signal of the control unit 300.

Next, an operation voltage corresponding to the generated antenna mode change signal of the control unit 300 according to the corresponding antenna mode is applied to the piezoelectric module 100 by the voltage control unit, such as voltage control unit 500, in operation S300 (S300). When the operation voltage is applied, the piezoelectric module 100 generates an operation frequency according to the operation voltage in operation S500. Also, an operation of generating a fundamental frequency according to the operation voltage and an operation of converting the fundamental frequency into an operation frequency may be included in operation S500, such as for GPS, WiFi or Bluetooth frequency bands, as previously described, for example.

The provided signals, such as an audio signal Sa and a communication signal Sc, are typically filtered, such as by the signal selection unit 700, according to the corresponding antenna mode to obtain a corresponding single signal or signals at operation S700. The signals may be passed by a band-pass filtering method, such as previously described. In addition, the signals may be modulated according to the corresponding antenna mode, as previously described, in operation S700, according to exemplary embodiments.

The obtained single signal is applied, or the obtained signals are applied, to the piezoelectric module 100 so as to be transmitted to the outside of the terminal 1 at operation S900. The signal is typically carried by a carrier wave according to the operation frequency of the antenna mode and is radiated or transmitted to the outside of the terminal 1, the piezoelectric module 100 operating as a transmitting antenna of the terminal 1. In addition, as previously described, the piezoelectric module 100 may operate as a receiving antenna of the terminal 1 by receiving an external signal through the carrier wave, according to exemplary embodiments.

In a case where the antenna function of the piezoelectric module 100 is completed, the control unit 300 may switch the operation mode of the piezoelectric module 100 to one or more other modes, such as one or more piezoelectric modes. In this case, the piezoelectric mode may be returned to the speaker mode or the motor mode in which the piezoelectric module 100 operates before being changed to the antenna mode, or may be changed to operate in another different mode, for example, according to exemplary embodiments.

In addition, as illustrated in FIG. 6, the piezoelectric module may be simultaneously, or at approximately the same time, implemented in two or more operation modes by alternately applying the two or more operation voltages to the piezoelectric module 100, such as one or more of operations voltages V1, V2, V3 or V4, respectively corresponding to an operation mode or operation modes of a plurality of operation modes, according to exemplary embodiments.

Also, aspects of the present invention are also directed to providing methods of using a piezoelectric module as an antenna in a terminal in order to enhance mounting characteristics and durability of the terminal, according to exemplary embodiments.

In this regard, terminals using a piezoelectric module as an antenna described above, according to exemplary embodiments, may be used as wireless interfaces applied to NFC, WiFi, GPS, or Bluetooth operations or applications, and the like, without typically including an additional configuration in the terminal by generating resonance using the piezoelectric element, with the piezoelectric element also being operated as a speaker or motor, for example. Therefore, the antenna may be implemented using the piezoelectric module that performs other operations, such as a speaker or motor in the terminal. And, thus, mounting characteristics and durability of the terminal may be enhanced. And designing of the inside and internal components of the terminal may be simplified, according to exemplary embodiments.

For example, a speaker in a terminal may have a height of equal to or greater than about 3 mm and may require a space of equal to or higher than about 4 mm taking into consideration of a resonance space for the speaker. On the other hand, the piezoelectric speaker may require a space of about 1 mm and a space of about 2 mm, taking into consideration a resonance space for the piezoelectric speaker.

Therefore, according to exemplary embodiments, for example, the antenna operation of a terminal may be implemented together with the speaker operation of the terminal by a piezoelectric element of a piezoelectric module. In addition, the antenna operation of a terminal may be likewise implemented together with the motor operation of the terminal by a piezoelectric element of a piezoelectric module. Accordingly, designing related to types and numbers of antennas to be included in a terminal, such as for the described various antenna types and modes, for example, may be simplified or reduced.

Aspects of the present invention promote advantages of space application and size by combining various antennas and implements additional operations and functions, such as those of a speaker and a motor, by using a piezoelectric module as an antenna in a terminal, according to exemplary embodiments, for example. Therefore, a reduction in thickness of the terminal may be promoted, and accordingly, an effect of enhancing product competitiveness and reducing cost of the terminal may be provided, as well.

Also, the exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal to operate a piezoelectric module as an antenna, the terminal comprising:
a piezoelectric module including a piezoelectric element to operate according to an operation mode of the terminal, the operation mode including an antenna mode to operate the piezoelectric module as an antenna;
a control unit to determine the operation mode of the piezoelectric module and to operate the piezoelectric module in the determined operation mode; and
a voltage control unit to apply an operation voltage to the piezoelectric module to generate an operation frequency according to the operation mode determined by the control unit.

2. The terminal of claim 1, wherein
the voltage control unit receives a mode signal from the control unit corresponding to the determined operation mode and applies the operation voltage to the piezoelectric module based on the received mode signal.

3. The terminal of claim 1, wherein
the voltage control unit alternately applies to the piezoelectric module a first operation voltage corresponding to a first operation mode and a second operation voltage corresponding to a second operation mode to operate the piezoelectric module alternately in the first operation mode and in the second operation mode.

4. The terminal of claim 3, wherein
the first operation mode is a piezoelectric mode and the second operation mode is the antenna mode.

5. The terminal of claim 1, wherein
the operation mode of the piezoelectric module comprises a plurality of operation modes including one or more piezoelectric modes and one or more antenna modes.

6. The terminal of claim 5, wherein
the one or more piezoelectric modes comprise one or more of a speaker mode to operate the piezoelectric module as a speaker and a motor mode to operate the piezoelectric module as a motor.

7. The terminal of claim 1, further comprising:
a frequency conversion unit to convert a generated fundamental frequency corresponding to the operation voltage into the operation frequency corresponding to determined operation mode.

8. The terminal of claim 1, further comprising:
a signal selection unit to receive a mode signal from the control unit corresponding to the determined operation mode and to filter one or more signals corresponding to one or more operation modes to provide one or more filtered signals corresponding to the determined operation mode.

9. The terminal of claim 1, further comprising:
a signal modulation unit to modulate a communication signal received from the control unit corresponding to the antenna mode to provide a modulation signal corresponding to the antenna mode.

10. The terminal of claim 9, wherein
the antenna mode comprises one or more of a main antenna mode, a near field communication (NFC) antenna mode, a wireless a wireless fidelity (WiFi) antenna mode, a global positioning system (GPS) antenna mode, and a Bluetooth antenna mode.

11. The terminal of claim 1, wherein
the antenna mode comprises a plurality of antenna modes and the voltage control unit alternately applies to the piezoelectric module a first operation voltage corresponding to a first antenna mode and a second operation voltage corresponding to a second antenna mode to operate the piezoelectric module alternately in the first antenna mode and in the second antenna mode.

12. The terminal of claim 11, wherein
the plurality of antenna modes comprise one or more of a main antenna mode, a near field communication (NFC) antenna mode, a wireless a wireless fidelity (WiFi) antenna mode, a global positioning system (GPS) antenna mode, and a Bluetooth antenna mode.

13. A terminal to operate a piezoelectric module as an antenna, the terminal comprising:
a piezoelectric module including a piezoelectric element to operate according to a plurality of operation modes of the terminal, the operation modes including one or more piezoelectric modes to operate the piezoelectric module as a speaker or a motor and one or more antenna modes to operate the piezoelectric module as an antenna;
a control unit to determine the one or more operation modes of the piezoelectric module to alternately operate the piezoelectric module in one or more of the determined operation modes; and
a voltage control unit to alternately apply operation voltages to the piezoelectric module to generate corresponding operation frequencies according to the operation modes determined by the control unit.

14. A method for operating a piezoelectric module as an antenna in a terminal, the method comprising:
determining an operation mode of a piezoelectric module to operate the piezoelectric module in the determined operation mode, the operation mode including an antenna mode to operate the piezoelectric module as an antenna;
applying an operation voltage to the piezoelectric module; and
generating an operation frequency corresponding to the applied operation voltage according to the determined operation mode.

15. The method of claim 14, further comprising:
generating a mode signal corresponding to the determined operation mode; and
applying the operation voltage to the piezoelectric module based on the received mode signal.

16. The method of claim 14, further comprising:
alternately applying to the piezoelectric module a first operation voltage corresponding to a first operation mode and a second operation voltage corresponding to a second operation mode; and
operating the piezoelectric module alternately in the first operation mode and in the second operation mode.

17. The method of claim 16, wherein
the first operation mode is a piezoelectric mode and the second operation mode is the antenna mode.

18. The method of claim 14, wherein
the operation mode of the piezoelectric module comprises a plurality of operation modes including one or more piezoelectric modes and one or more antenna modes.

19. The method of claim 18, wherein
the one or more piezoelectric modes comprise one or more of a speaker mode to operate the piezoelectric module as a speaker and a motor mode to operate the piezoelectric module as a motor.

20. The method of claim 14, further comprising:
converting a generated fundamental frequency corresponding to the operation voltage into the operation frequency corresponding to determined operation mode.

21. The method of claim 14, further comprising:
generating a mode signal corresponding to the determined operation mode; and
filtering one or more signals corresponding to one or more operation modes to provide to the piezoelectric module one or more filtered signals corresponding to the determined operation mode based on the generated mode signal.

22. The method of claim 14, further comprising:
modulating a communication signal corresponding to the antenna mode to provide a modulation signal to the piezoelectric module corresponding to the antenna mode.

23. The method of claim 14, wherein
the antenna mode comprises one or more of a main antenna mode, a near field communication (NFC) antenna mode, a wireless a wireless fidelity (WiFi) antenna mode, a global positioning system (GPS) antenna mode, and a Bluetooth antenna mode.

24. The method of 14, further comprising:
alternately applying to the piezoelectric module a first operation voltage corresponding to a first antenna mode and a second operation voltage corresponding to a second antenna mode to operate the piezoelectric module alternately in the first antenna mode and in the second antenna mode,
wherein the antenna mode comprises a plurality of antenna modes.

25. A method for operating a piezoelectric module in a plurality of operation modes, the method comprising:
determining one or more operation modes of the piezoelectric module to alternately operate the piezoelectric module in a plurality of operation modes, the operation modes including one or more piezoelectric modes to operate the piezoelectric module as a speaker or a motor and one or more antenna modes to operate the piezoelectric module as an antenna;
alternately applying operation voltages corresponding to the determined plurality of operation modes to the piezoelectric module; and
generating operation frequencies corresponding to the applied operation voltages according to the determined plurality of operation modes.
